(19) United States
(12) Patent Application Publication
(10) Pub. No.: US 2020/0198276 A1
(43) Pub. Date: Jun. 25, 2020

(54) METHOD OF BUILDING A TIRE WITH NO BEAD TURNUP

(71) Applicant: The Goodyear Tire & Rubber Company, Akron, OH (US)

(72) Inventors: George Michael Stoila, Tallmadge, OH (US); John Edward Anderson, Atwater, OH (US); Michael James Hogan, Tallmadge, OH (US); Philippe Joseph Auguste Muller, Champlon (BE); Gilles Bonnet, Niederfeulen (LU); Gilles Reichling, Vichten (LU); Robert Edward Lionetti, Bereldange (LU); Frederic Marie Bernard Marechal, Selange (BE); Olivier Di Prizio, Hettange-Grande (FR); Nicolas Soultis, Freylange (BE)

(21) Appl. No.: 16/655,318

(22) Filed: Oct. 17, 2019

Related U.S. Application Data
(60) Provisional application No. 62/782,479, filed on Dec. 20, 2018.

(51) Int. Cl. B29D 30/32; B29D 30/30; B60C 15/00

(52) U.S. Cl. CPC B29D 30/32; B60C 15/0018; B29D 30/30

(57) ABSTRACT

A method of building a tire having no ply turnup is described. The method includes the steps of applying an inner liner and chafer onto a tire building drum; radially expanding the center portion of the drum and applying a first column bead, applying a layer of ply followed by a second column bead, turning up the chafer and then inflating the carcass under low pressure below 150 mbars, applying the tread, applying the sidewall. A method of molding a green tire having a first and second bead area is described herein, wherein the method includes the steps of: inserting a tire clamping device inside a tire bladder and then inserting the tire clamping device and the bladder into the green tire, aligning the outer surfaces of the tire clamping device are in engagement with a respective bead area of the tire so that each tire bead area is clamped between a respective upper and lower mold ring and the tire clamping device during cure.

### FIELD OF THE INVENTION

The invention relates generally to tires and more particularly to a pneumatic tire.

### BACKGROUND OF THE INVENTION

For high performance and ultrahigh performance tires, it is often desired to eliminate the ply turnup around the bead. Eliminating the ply turnup removes the stress concentration and allow construction using larger diameter reinforcing cords. However, it is difficult to build the tire without building the tire on a solid core. The ply cord typically pulls out from the bead during the tire curing process, because of the rapid expansion and transformation from green built dimensions to cured dimensions of the tire carcass during the cure process. The solid core eliminates the movement of the carcass. However, building a tire on a solid core requires special equipment and often is a much slower tire building process. Thus, it is desired to provide a method and apparatus for building a tire that has no ply turnup using conventional tire building equipment.

### SUMMARY OF THE INVENTION

The invention provides in a first aspect of the invention a method of molding a green tire having a first and second bead area, the method comprising the steps of : inserting a tire clamping device inside a tire bladder and then inserting the tire clamping device and the bladder into the green tire, aligning the outer surfaces of the tire clamping device into engagement with a respective bead area of the tire and a respective upper and lower mold ring so that each bead area is clamped between the respective mold ring and the tire clamping device during cure.

### Definitions

“Aspect ratio” of the tire means the ratio of its section height (SH) to its segment width (SW) multiplied by 100 percent for expression as a percentage.

“Axial” and “axially” means lines or directions that are parallel to the axis of rotation of the tire.

“Chafer” is a narrow strip of material placed around the outside of a tire bead to protect the cord plies from wearing and cutting against the rim and distribute the flexing above the rim.

“Circumferential” means lines or directions extending along the perimeter of the surface of the annular tread perpendicular to the axial direction.

“Equatorial Centerplane (CP)” means the plane perpendicular to the tire's axis of rotation and passing through the center of the tread.

“Footprint” means the contact patch or area of contact of the tire tread with a flat surface at zero speed and under normal load and pressure.

“Groove” means an elongated void area in a tire dimensioned and configured in segment for receipt of an air tube therein.

“Inboard side” means the side of the tire nearest the vehicle when the tire is mounted on a wheel and the wheel is mounted on the vehicle.

“Lateral” means an axial direction.

“Lateral edges” means a line tangent to the axially outermost tread contact patch or footprint as measured under normal load and tire inflation, the lines being parallel to the equatorial centerplane.

“Outboard side” means the side of the tire farthest away from the vehicle when the tire is mounted on a wheel and the wheel is mounted on the vehicle.

“Radial” and “radially” means directions radially toward or away from the axis of rotation of the tire.

“Rib” means a circumferentially extending strip of rubber on the tread which is defined by at least one circumferential groove and either a second such groove or a lateral edge, the strip being laterally undivided by full-depth grooves.

“Sipe” means small slots molded into the tread elements of the tire that subdivide the tread surface and improve traction, sipes are generally narrow in width and close in the tires footprint as opposed to grooves that remain open in the tire's footprint.

“Tread element” or “traction element” means a rib or a block element defined by a shape with adjacent grooves.

“Tread Arc Width” means the arc length of the tread as measured between the lateral edges of the tread.

### BRIEF DESCRIPTION OF THE DRAWINGS

The invention will be described by way of example and with reference to the accompanying drawings in which:

FIG. 1 is a cross-sectional view of a tire with no bead turnup;

FIG. 2 is a close-up view of the bead area of the tire of FIG. 1 and depicts variants in wires for bead columns;

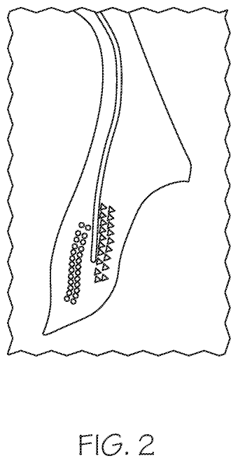

FIG. 3 is a schematic of a tire building drum shown with the inner liner, chafer, and toeguard applied;

FIG. 4 illustrates the tire building drum shown with the crown expanded;

FIG. 5 illustrates the tire building drum shown with the crown expanded and the first bead being formed;

FIG. 6 illustrates the tire building drum shown with the crown expanded and the ply layer being applied;

FIG. 7 illustrates the tire building drum shown with the crown expanded and the second bead being formed;

FIG. 8 illustrates the tire building drum shown with the crown expanded and the chafers being turned up by bladders;

FIG. 9 illustrates the green carcass being inflated with no bead lock pressure;

FIG. 10 illustrates the tread being applied to the shaped green carcass;

FIG. 11 illustrates the application of the sidewall over the tread;

FIG. 12 illustrates a perspective view of a tire clamping device in the closed position;

FIG. 13 illustrates a top view of the tire clamping device of FIG. 12 in the closed position;

FIG. 14 illustrates a perspective view of the tire clamping device in the open position; and

FIG. 15 illustrates a cross-segmental schematic of a tire in the tire mold with the ply clamping device and bladder installed.

### DETAILED DESCRIPTION OF THE PRESENT INVENTION

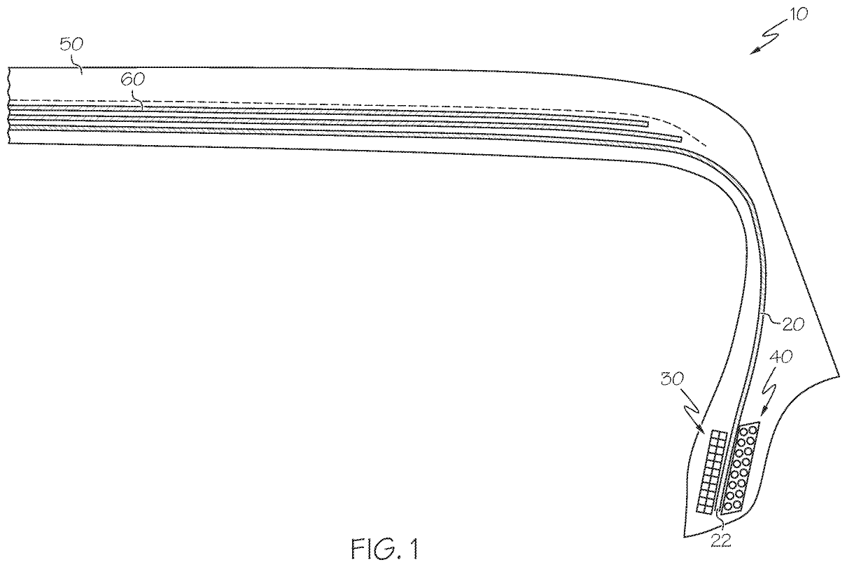

FIG. 1 illustrates a tire 10 of the present invention that has no bead turnup. The tire 10 has a single layer or monolayer of ply 20, that has a radially inner portion 22 that is clamped between a first column bead 30 and a second column bead 40. The tire 10 may further include a tread 50, and belts 60. The invention is not limited to the beads columns as shown. There could also be variants of the columns inside or outside of the ply. Columns could be formed by traditional strap beads in the configuration of 2=11. Columns could also be made by spirally winding various wire treatments.

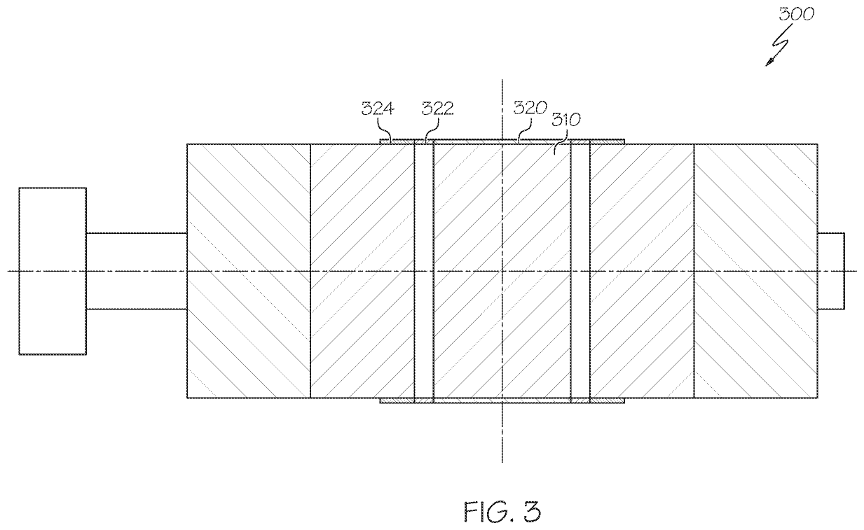

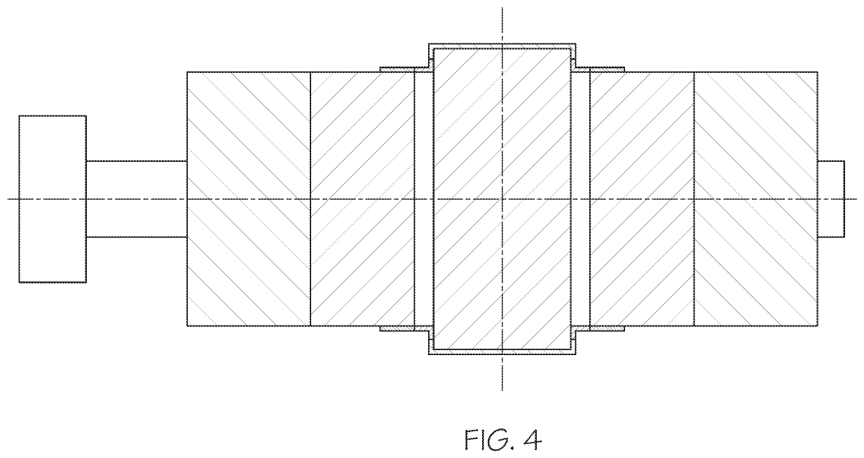

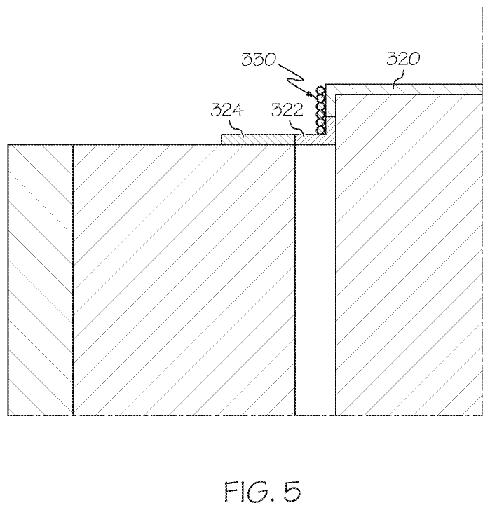

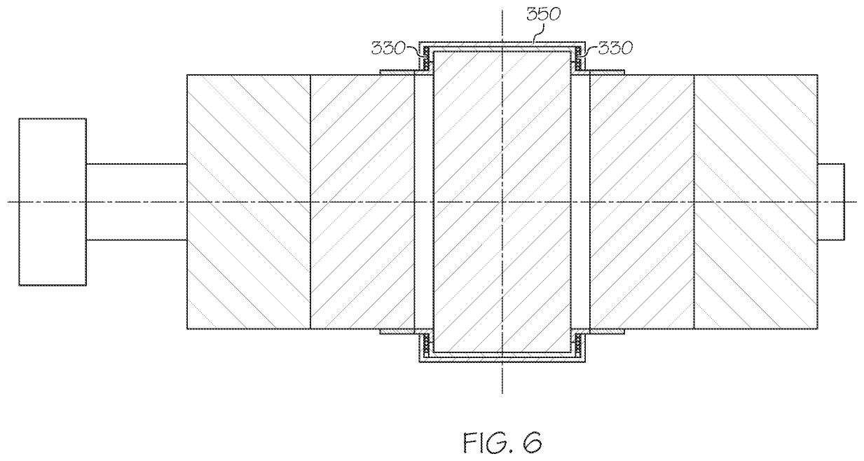

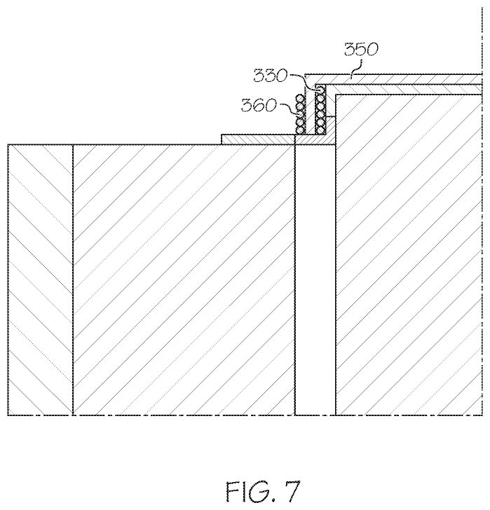

The tire 10 may be formed on a conventional two stage tire building drum 300 that has a crowning or radially expandable center portion 310, where crowning and bead locking functions are fully independent of each other. FIG. 3 illustrates that the tire 10 may be building by applying the inner liner 320, toeguard 322 and chafer 324 to the tire building drum. As shown in FIG. 4, the tire drum center portion may be radially expanded. As shown in FIG. 5, the first column bead may be applied by either applying a preassembled column bead 330 onto the tire drum, or by spirally winding a continuous wire onto the drum to form a column bead 330. Those skilled in the art would understand that the apparatus (not shown) to create a forging force to friction weld the materials together. Also, those skilled in the art would understand that various chemical adhesive coupons could be added to the assembly for additional welding in the green state. The column bead may be preassembled with an apex (not shown). Next, as shown in FIG. 6 a single layer of ply 350 is applied onto the drum. Next, as shown in FIG. 7, the drum is rotated as a wire is wound onto the assembly to form a second column bead 360. A second apex is then applied adjacent the second bead 360. The first and second column bead function to clamp the ply.

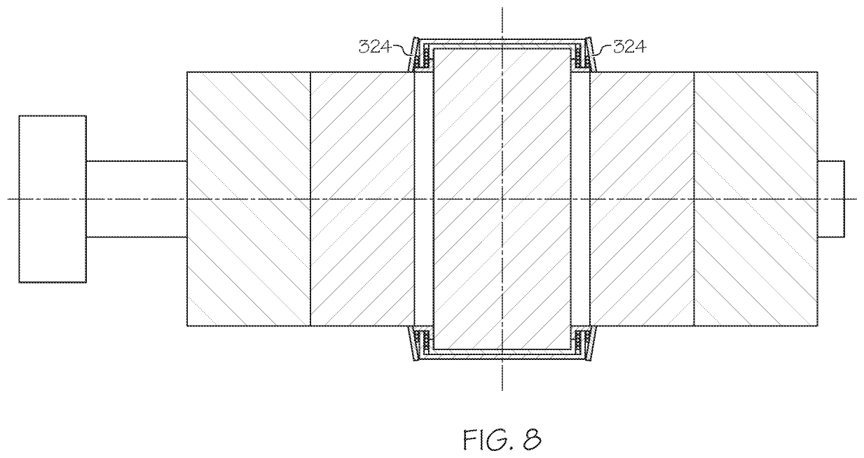

FIG. 8 illustrates that the chafer 324 is turned up by the bladders (not shown) of the tire building drum.

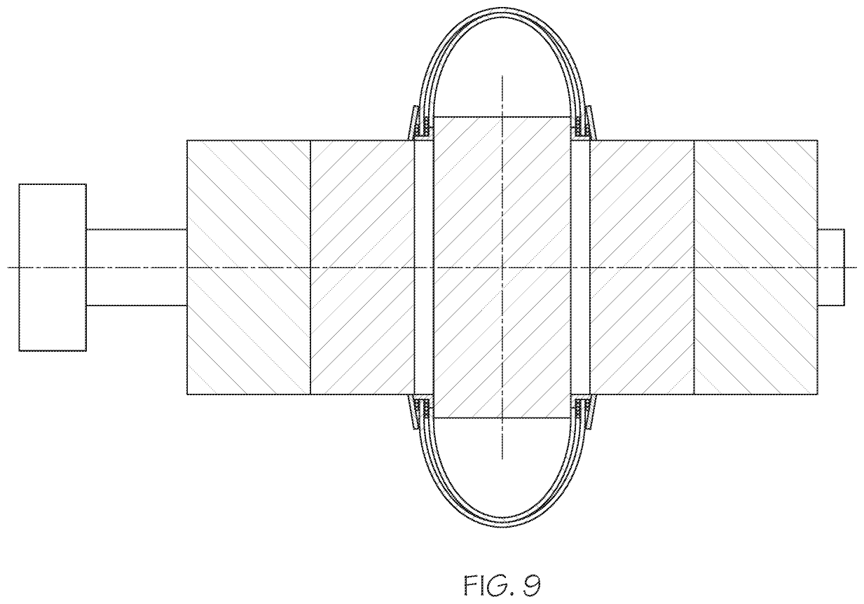

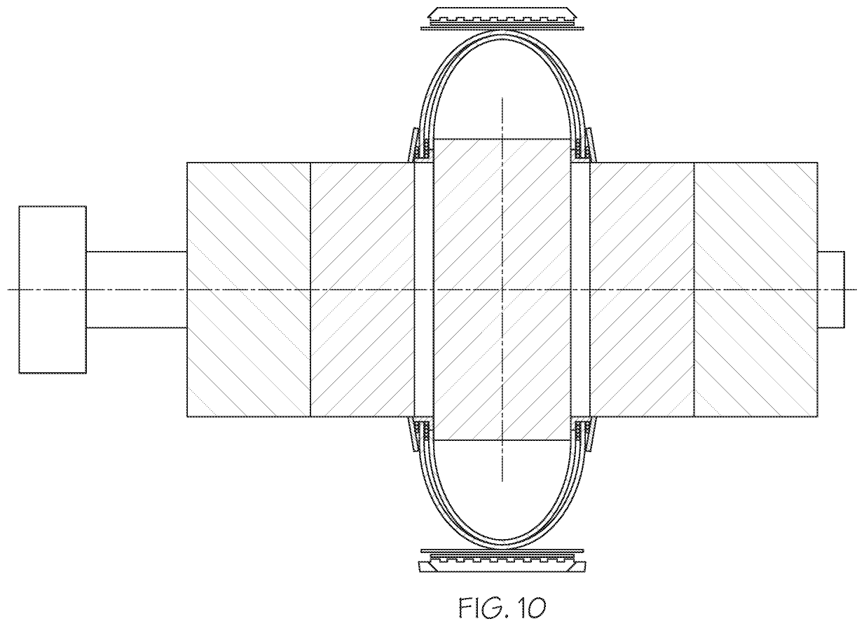

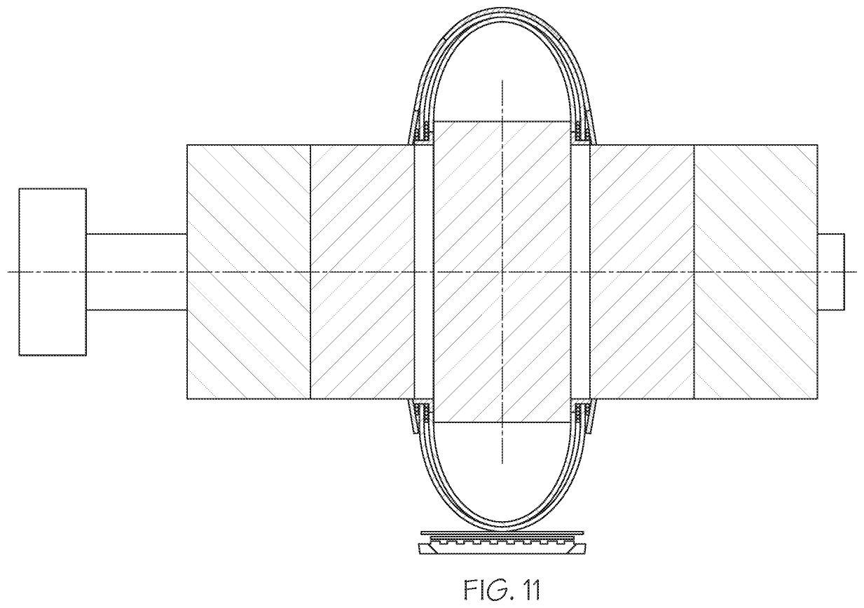

FIG. 9 illustrates that the carcass is inflated using low pressure air, under 150 mBars. There is minimal bead lock force being applied; only enough force to seal the carcass shaping air from leaking. FIG. 10 illustrates that the tread is applied to the inflated carcass and then stitched. FIG. 11 illustrates that the sidewall is then applied, wherein the sidewall has a radially outer portion that extends over laterally outer end of the tread.

Next, the shaped green tire is removed from the drum. In order to cure the tire, the tire clamping device 100 as described in more detail, below, is inserted inside a curing bladder (not shown). Next, the tire curing bladder with the tire clamping device inside is positioned in the mold. A vacuum is drawn on the tire bladder which results in the tire clamping device being collapsed into the closed position. Next, the green carcass is slipped over the closed tire clamping device and bladder. Next, the bladder is inflated and the springs of the tire clamping device are released, so that the segments are biased in a radially outward direction. The bead area 300 of the green carcass and bladder is clamped between the outer portions 122,120 of the tire clamping device and the respective upper and lower mold rings 230,240. Next, the tire is cured when the tire clamping device is in place to ensure that the ply remains positioned between the beads during cure and not pulled out of place due to the tire shaping pressure. Thus, the tire clamping device is sized so that when in the collapsed position, its outer diameter is less than the bead diameter, and capable of resiliently expanding so that its outer diameter in the expanded position is greater than the bead diameter of the green carcass to be cured.

### Tire Clamping Device

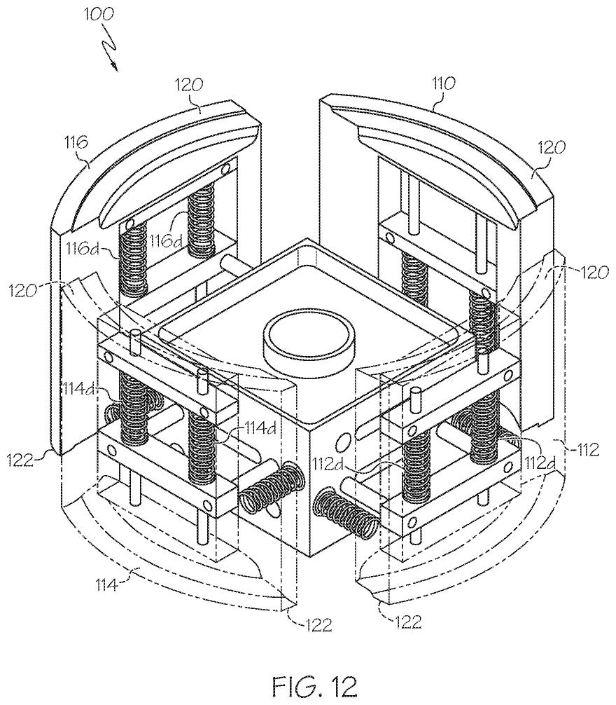

FIG. 12 illustrates a perspective view of a tire clamping device 100 that is used to clamp the bead area of the tire in the mold to ensure the ply of the green carcass is clamped between the tire clamping device 100 and the tire mold. This allows a tire to be cured that does not have a ply turnup, and solves the problem of ply pullout during the cure when the tire is cured without a core.

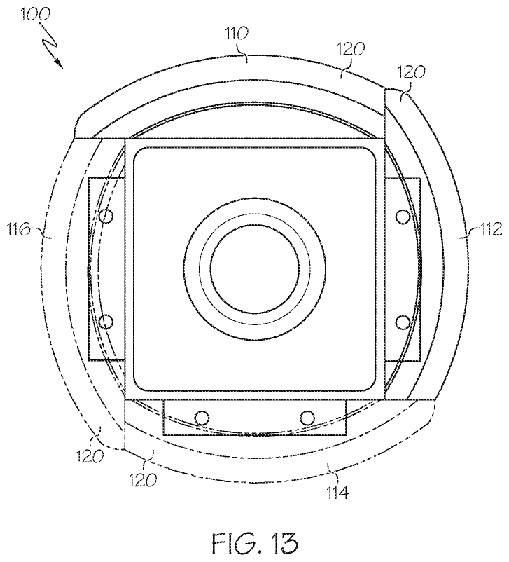

The tire clamping device 100 includes a plurality of segments 110,112,114 and 116. As shown in FIG. 13, when the segments are in the fully closed position, the tire clamping device has a round shape. The plurality of segment when joined together in the closed position, form outer rings 120,122 that engages the tire bead and the lower radial portion of the curing bladder 130 and hold the ply in place during cure.

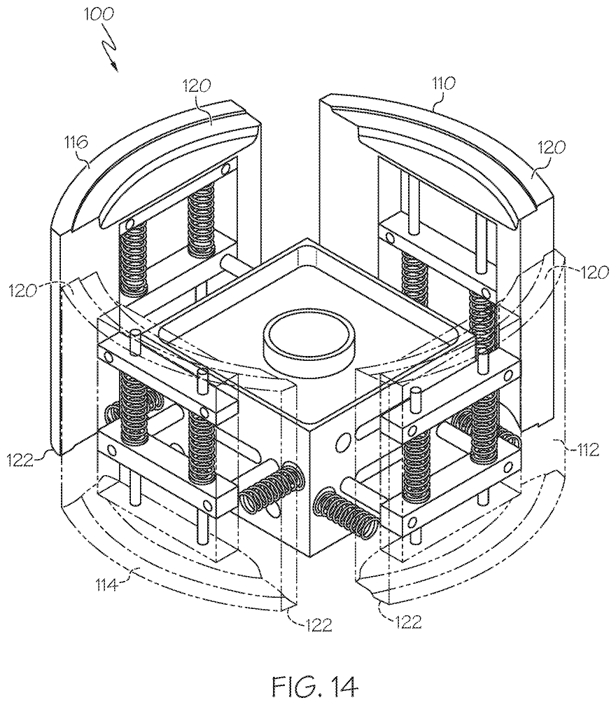

FIG. 14 illustrates that the segments 110,112,114, and 116 each have respective radially oriented springs 116a,b, 110a,b, 112a,b and 114a,b. The radially oriented springs bias the segments 110,112,114,116 in the radially expanded position. Each segment also has guide rails 110c,112c,114c,116c. The radially oriented springs and the guide rails are located between the respective segments and an inner portion 130, in the example shown as a center square block 130 (although not limited to the square configuration).

FIG. 14 illustrates that the segments 110,112,114, and 116 each have transverse or axially oriented (with respect to the tire) springs 110d,112d,114d, and 116d that are perpendicular to the radially oriented springs. The springs may be replaced with other mechanical mechanisms known to those skilled in the art, to facilitate opening and closing the tire clamping device.

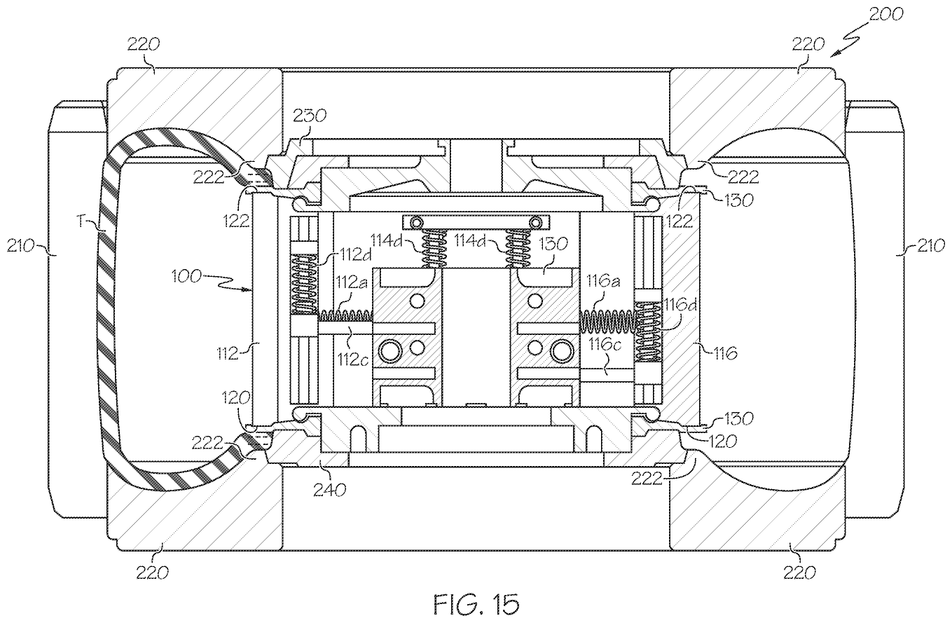

FIG. 15 illustrates a typical mold 200 used for curing passenger tires. The mold 200 has tread plates 210 for molding the tread of a tire, and sidewall plates 220 for forming the sidewalls of the tire. Each sidewall plates has a lower portion 222 located in the bead area of the tire. The mold further includes upper and lower mold rings 230,240 that are located adjacent the lower portion 222 of the sidewall plates. The the mold rings work together with the tire clamping device to clamp the ply and bead area of the green tire during the cure.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed:

1. A method of building a tire having no ply turnup, the method comprising the steps of:
applying an inner liner and chafer onto a tire building drum;
radially expanding the center portion of the drum and applying a first column bead;
applying a layer of ply followed by a second column bead; and
turning up the chafer and then inflating the carcass under low pressure below 150 mbars, applying the tread, applying the sidewall.

2. The method of claim 1 wherein the first column bead is formed by winding a wire onto the tire building drum.

3. The method of claim 1 wherein the second bead is formed by winding a wire onto the tire building drum.

4. The method of claim 1 further comprising the steps of molding a green tire having a first and second bead area, the method comprising the steps of:
inserting a tire clamping device inside a tire bladder and then inserting the tire clamping device and the bladder into the green tire; and
aligning the outer surfaces of the tire clamping device into engagement with a respective bead area of the tire so that each tire bead area is clamped between a respective upper and lower mold ring and the tire clamping device during cure.

5. A method of molding a green tire having a first and second bead area, the method comprising the steps of:
inserting a tire clamping device inside a tire bladder and then inserting the tire clamping device and the bladder into the green tire; and
aligning the outer surfaces of the tire clamping device into engagement with a respective bead area of the tire so that each tire bead area is clamped between a respective upper and lower mold ring and the tire clamping device during cure.

6. The method of claim 1 further comprising the step of pulling a vacuum so that the tire clamping device is positioned into the closed position.

7. The method of claim 1 further including the step of inflating the bladder so that the segments of the tire clamping device are resiliently biased into an open position.
